(19) United States
(12) Patent Application Publication
(10) Pub. No.: US 2025/0001596 A1
(43) Pub. Date: Jan. 2, 2025

(54) METHOD, LASER-OPTICAL DETECTION SYSEM AND ROBOTIC WORKSTATION

(71) Applicant: KUKA Deutschland GmbH, Augsburg (DE)

(72) Inventor: Thomas RUEHR, Erlangen (DE)

(73) Assignee: KUKA Deutschland GmbH, Augsburg (DE)

(21) Appl. No.: 18/710,460

(22) PCT Filed: Oct. 11, 2022
(86) PCT No.: PCT/EP2022/078228

§ 371 Date: Jun. 13, 2024

(30) Foreign Application Priority Data
Nov. 25, 2021 (DE) 10 2021 130 999.9

(51) Int. Cl. B25J 9/16; B25J 19/02

(52) U.S. Cl. CPC B25J 9/1653; B25J 19/022

(57) ABSTRACT

A method and a laser-optical detection system including a laser projector, a camera, a control device which is designed and configured to actuate the laser projector and the camera in order to determine features of the object, and a sensor unit. The control device is configured such that, as a function of the characterizing signal obtained by the sensor unit relating to an approach or the presence of a person in a critical spatial proximity to the laser projector, the exposure parameters of the camera are adjusted as a function of the reduced maximum irradiation intensity of the laser projector in relation to the current irradiation intensity of the laser projector. A robotic workstation includes a laser optical detection system of this type.

### CROSS-REFERENCE TO RELATED APPLICATIONS

This application is a national phase application under 35 U.S.C. § 371 of International Patent Application No. PCT/EP2022/078228, filed Oct. 11, 2022 (pending), which claims the benefit of priority to German Patent Application No. DE 10 2021 130 999.9, filed Nov. 25, 2021, the disclosures of which are incorporated by reference herein in their entirety.

### TECHNICAL FIELD

The invention relates to a method for controlling a laser-optical detection system and a corresponding laser-optical detection system, having a laser projector which is designed to emit laser light of predetermined patterns in a predetermined wavelength range with a predetermined irradiation intensity in order to project it onto an object, a camera which is designed to optically detect the pattern reflected on the object, which is projected onto the object by the laser projector, wherein the camera is configured to detect the reflected pattern by an optical system under predetermined exposure parameters, a control device which is designed and configured to actuate the laser projector and the camera in order to determine features of the object, and a sensor unit which is designed to detect an approach or the presence of a person in a critical spatial proximity to the laser projector, and which is configured to transmit a signal characterizing the approach or the presence of the person to the control device so that the control device reduces the maximum irradiation intensity of the laser projector to a permissible value based on the characterizing signal, as a function of the approach or presence of the person. The invention also relates to a robotic workstation with such a laser-optical detection system.

### BACKGROUND

WO 2006/113848 A2 describes a laser projection system with a proximity detector system for personal protection in order to recognize any approach of a person within a predetermined protection zone. If a person's approach within a predetermined zone is recognized, the laser power is either interrupted or reduced to a safe level or to a level defined as safe for the detected approach distance. An electronic circuit directly modifies the output power of the laser projector to an approved level based on feedback of the speed of the scanned beam and the recognized closest approach distance.

### SUMMARY

The object of the invention is to provide a method and a laser-optical detection system which can be used at an automated workstation, in particular a robotic workstation, in such a way that the laser-optical detection system can continue to be operated even in a set-up mode.

The object is achieved by a method for controlling a laser-optical detection system, having the steps:
projecting laser light of a predetermined pattern in a predetermined wavelength range with a predetermined irradiation intensity onto an object,
optically detecting the pattern reflected from the object which has been projected onto the object by means of a camera which records an image of the reflected pattern through an optical system under predetermined exposure parameters,
determining features of the object based on the recorded image of the reflected pattern,
reducing a maximum irradiation intensity of the laser light to a permissible value as a function of an approach or presence of a person in a critical spatial proximity to the laser light, and
adjusting the camera exposure parameters as a function of the reduced maximum irradiation intensity of the laser light.

The object is accordingly also achieved by a laser-optical detection system, in particular for carrying out the method, comprising:
a laser projector that is designed to emit laser light of predetermined patterns in a predetermined wavelength range with a predetermined irradiation intensity to project it onto an object,
a camera which is designed to optically detect the pattern reflected on the object, which is projected onto the object by the laser projector, wherein the camera is configured to detect the reflected pattern by an optical system under predetermined exposure parameters,
a control device which is designed and configured to actuate the laser projector and the camera in order to determine features of the object,
a sensor unit which is designed to detect an approach or the presence of a person in a critical spatial proximity to the laser projector, and which is configured to transmit a signal characterizing the approach or the presence of the person to the control device so that the control device reduces the maximum irradiation intensity of the laser projector to a permissible value based on the characterizing signal, as a function of the approach or presence of the person, wherein
the control device is configured such that, as a function of the characterizing signal obtained by the sensor unit relating to the approach or the presence of the person in the critical spatial proximity to the laser projector, it adjusts the exposure parameters of the camera as a function of the reduced maximum irradiation intensity of the laser projector in relation to the current irradiation intensity of the laser projector.

The laser-optical detection system can be used in an automated workstation, such as a robotic workstation. During automated handling of workpieces and/or tools, objects, i.e. the workpieces or the tools, are gripped, moved or otherwise manipulated. A typical example of automated handling of objects at a robotic workstation is the automatic picking of a workpiece out of a box using a gripping tool guided by a robot arm. If one or more workpieces are present in the box unsorted, a detection system is required that can automatically detect the position and orientation of a specific object that is to be gripped by the gripping tool guided by the robot arm. Electronic laser-optical detection systems are usually used for this purpose.

Such laser-optical detection systems generally comprise a laser projector and a camera. The laser projector emits laser light and shines the laser light onto the object to be detected. The laser light is not emitted diffusely onto the object, but in a specified pattern. The specified pattern can comprise a plurality of individual light points and/or one or more light lines. In this respect, structured light is projected onto the object to be measured, and its reflections on the surface of the object are detected by the camera. The image detected by the camera of the light pattern reflected from the object can then be evaluated using image analysis, in order to be able to recognize characteristic features of the object and be able to measure their exact position and orientation. Based on the evaluated images of the object, the gripping tool can be moved towards the object by automatically controlling the robot arm, so that the robot arm or gripping tool can grasp the detected object and remove it from the box.

An example of a common projection method for detecting the characteristic features of an object is strip projection, which can also be referred to as strip light scanning. Image sequences, i.e. a sequence of a plurality of images taken sequentially over time, can be generated from which the surface of the object can be detected or measured, particularly in three dimensions. Since the mutual position and orientation of the laser projector and the camera are known, the points imaged in the camera, for example along a strip, can be compared with the known alignment of the strip generated by the projector and their three-dimensional position or orientation can be calculated, for example by triangulation. With the so-called light section method, a flat beam of light is projected onto the object to be detected. This beam of light creates an optically detectable line on the object. Viewed from the projector's alignment, the lines are straight. From the laterally offset optical axis of the camera, the lines appear deformed according to the object geometry due to the perspective distortion on the surface of the object. The deviation from the straightness of the lines, i.e. the deformation of the lines in the camera image, is a measure of the object shape. The method can be extended to improve the evaluation by simultaneously projecting a plurality of parallel lines, i.e. a set of lines or a grid of lines, onto the object to be detected.

Another exemplary projection method for detecting the characteristic features of the object is laser scanning. The object is passed over, i.e. scanned line by line or in a grid pattern with a laser beam. The light emitted by the laser beam is also reflected on the object and detected by a camera, and the detected images are evaluated.

Depending on the projection method, the laser light emitted by the laser projector can be generated in different wavelengths or wavelength ranges. Common strip light projectors emit monochromatic light in the visible range, i.e. in the wavelength range from approximately 400 nanometers to 700 nanometers. However, laser light can also emit light in non-visible ranges in the near infrared range (approximately 700 nanometers to 2.6 micrometers) and the mid-infrared range (approximately 2.6 micrometers to 30 micrometers) as well as in the ultraviolet range (approximately 180 nanometers to 400 nanometers).

In addition to the wavelength of the emitted laser light and the duration of the emission, the irradiation intensity, i.e. the power density of the emitted laser light, is also relevant with regard to a possible health risk to persons. For example, the European Directive 2006/25/EC on the minimum health and safety requirements regarding the exposure of the workers to risks arising from physical agents (artificial optical radiation) defines limit values for eye exposure to laser beams.

During automatic operation at the automated workstation such as the robotic workstation mentioned above, the access restriction to the workstation that is required in any case reliably prevents a person from coming so close to the laser-optical detection system that there would be a health risk for the person due to the emitted laser light.

However, in another operating mode, for example in set-up mode, it may be necessary for a person to enter the automated workstation, in order to carry out activities in the immediate vicinity of the laser-optical detection system or at least in its danger area in which laser light can occur, for example recording or adjusting path points for the movements of the robot arm (teach-in). Until now, the laser-optical detection system had to be switched off completely, or at least the laser power had to be significantly reduced, in order to exclude any risk to the health of the individual. In a switched-off state, the laser-optical detection system is unavailable. In an operating mode of the laser-optical detection system with significantly reduced laser power, the functionality of detecting objects is often limited or even no longer reliably possible, which is disadvantageous.

The invention therefore proposes not only to provide a sensor unit which is designed to detect an approach or the presence of a person in a critical spatial proximity to the laser projector, and which is configured to transmit a signal characterizing the approach or the presence of the person to the control device so that the control device reduces the maximum irradiation intensity of the laser projector to a permissible value based on the characterizing signal as a function of the approach or the presence of the person, but also to design the control device such that, as a function of the characterizing signal obtained by the sensor unit relating to the approach or the presence of the person in the critical spatial proximity to the laser projector, it adjusts the exposure parameters of the camera as a function of the reduced maximum irradiation intensity of the laser projector in relation to the current irradiation intensity of the laser projector.

If, in addition to reducing the power of the laser-optical detection system and therefore the irradiation intensity of the laser projector, the exposure parameters of the camera are also adjusted according to the reduced irradiation intensity, the laser-optical detection system can continue to be used without any qualitative restrictions, albeit with a reduced detection speed. However, a reduced detection speed of objects by the laser-optical detection system is not important in the set-up mode mentioned above, since in such a set-up mode, the robot arm can only be moved at a reduced travel speed in any case; in other words, the performance of the entire robotic system is reduced. For the example mentioned above of recording or adjusting path points of the robot path for the movements of the robot arm or its tool or gripper, or for testing a recorded robot program in non-automatic mode, a slower, i.e. less powerful, detection of the objects by the laser-optical detection system is sufficient, because the movements of the robot arm in non-automatic mode do not exceed a maximum permissible travel speed.

For precise and rapid recognition of three-dimensional objects such as workpieces, detection systems are used that are equipped with active lighting, which, for example in the case of laser light, can be dangerous for a person's eyes, i.e. are not eye-safe. This means that if a person looks directly into the lighting, this can lead to eye damage. This is the case, for example, in the depalletizing of cast parts in the automotive industry. Some of the pallets are filled up to 1.2 meters high. At the same time, the accuracy of the 3D point cloud obtained by the detection system should also be better than 1.0 millimeters at the bottom of the pallet. With regard to the spatial arrangement of the laser projector and camera, the handling robot arm with a gripper should also be able to be arranged between the permanently installed camera and the laser projector, for example a strip light projector.

One solution is to provide a high laser power for the laser projector. The advantage of high laser power is the ability to use a shorter exposure time in the camera which results in a faster cycle. With strip light projections, many different patterns can be projected. An image must be recorded for each pattern, so that the individual exposure times can quickly add up to over a second. At the same time, a relatively small aperture is required to obtain a greater depth of field, so that a high level of sharpness is ensured across the entire depth of the palette, which in turn requires more light.

When starting up or if there are problems in the cell, the detection system or its laser projector must therefore be safely switched off. If the operator then, for example, wants to move a part on the pallet and take a new picture, it is highly cumbersome.

It is more beneficial for the operator if the laser projector does not have to be switched off completely, but rather, similar to the robot technology, is slowed down if an operator approaches, and the power of the projector is also reduced, so that the operator can move within the robotic workstation without the risk of eye damage.

The entry of the operator into the cell can be recognized by known safety technology. This can be a fence with a door, but also a security laser scanner or a security camera, a step field or the like.

If safe operation is necessary and an approach of a person is recognized, the power of the laser projector should be reduced. In order to continue to achieve the same image quality or accuracy of the 3D data detection, according to the invention the exposure time of the sensor per pattern is extended, in particular in the same ratio. In particular, the reduction in power should be just large enough for the operator to be protected. In the case of an intelligent camera, a corresponding actuation can be implemented in the camera itself. For this purpose, the camera can have a safe input that reduces the laser power directly when using safe technology. The control software of the camera can also automatically extend the exposure time per projection pattern, in particular when using non-safe technology, so that the quality of the images remains at least approximately the same.

In a development, the switching or adjustment of the power can take place in real time, and the currently projected pattern can be shown longer at reduced power. This does require an extension of the exposure time, but this usually cannot be adjusted during the recording.

Alternatively, it is sufficient to recognize the change in power and, if necessary, repeat a single projection if it overlaps in time with the power reduction. In the simplest case, the entire recording with all patterns can be repeated if the power of the laser projector was reduced during a recording.

The laser projector is designed to emit laser light of predetermined patterns in a predetermined wavelength range with a predetermined irradiation intensity to project it onto an object.

Depending on the type of laser projector and/or the use of the detection, i.e. the type of objects to be detected, the predetermined patterns can be, for example, a plurality of points, one line or a plurality of lines, or 2-dimensional grids or rasters. The pattern emitted in each individual case is either predetermined by the selection of the design of the laser projector or set, i.e. configured, by control technology using assigned parameters in the laser projector.

The predetermined wavelength or, in particular in the case of non-monochromatic laser projectors, the predetermined wavelength range can also be predetermined by the type of laser projector depending on the design, or can be set manually or automatically by a configuration in the laser projector.

The irradiation intensity of the laser projector must be adjustable, i.e. changeable, so that the maximum irradiation intensity can be automatically reduced according to the invention. The reduction of the maximum irradiation intensity takes place automatically, and in particular based on the signals provided by the sensor unit which are characteristic of the approach or presence of a person.

The camera is designed to optically detect the pattern reflected on the object, which is projected onto the object by the laser projector, wherein the camera is configured to detect the reflected pattern by an optical system under predetermined exposure parameters.

The optical system can comprise one or more optical lenses. The optical system can, for example, be a lens system. The optical system or lens system is part of the camera. The optical system or the lens system can, for example, be designed to image the detected laser light reflected from the object onto an electronic sensor array, so that a corresponding image can be obtained as a digital data set and further processed electronically. The optical system or the lens system can have an adjustable aperture, whose opening width is automatically adjustable, i.e. settable. The electronic sensor array can be automatically adjustable, i.e. settable, in its light sensitivity. For example, it can be provided that a certain exposure index can be automatically selected from a plurality of possible exposure indices.

A control device is designed and configured to actuate the laser projector and the camera to determine features of the object.

The control device can therefore actuate both the laser projector and actuate the camera. The control device according to the present invention can be contained in a common control unit. Alternatively, the control device can have a plurality of subcomponents which are connected to one another in terms of control technology or can communicate with one another, but can be arranged spatially separated from one another. For example, one subcomponent of the control device can be spatially integrated into the laser projector, and another subcomponent of the control device can be spatially integrated into the camera.

The control device can in particular be designed and configured to automatically set or change the predetermined pattern which the laser projector is to emit. The control device can in particular be designed and configured to adjust the maximum irradiation intensity of the laser projector, in particular to limit it to a maximum value. The control device can also be designed and configured to automatically set or change the exposure parameters of the camera.

A sensor unit is designed to detect an approach or the presence of a person in a critical spatial proximity to the laser projector.

The sensor unit can, for example, detect if a person falls below a certain minimum distance from the light exit of the laser projector and/or enters a certain critical sector around the laser projector. In such a case, the maximum irradiation intensity of the laser projector can be directly limited to a permissible value.

Alternatively, a gradual approach of the person to the light exit of the laser projector and/or a gradual approach to a critical sector around the laser projector can be detected, in particular measured, and depending on the current distance of the person, the maximum irradiation intensity of the laser projector can be continuously reduced to a permissible value, and in particular as a function of the remaining distance of the person from the light exit of the laser projector and/or from the critical sector around the laser projector.

The sensor unit is configured to transmit a signal characterizing the approach or the presence of the person to the control device so that the control device reduces the maximum irradiation intensity of the laser projector to a permissible value based on the characterizing signal, as a function of the approach or presence of the person.

The characterizing signal can comprise information about the distance of the person from the light exit of the laser projector and/or from the critical sector around the laser projector. The characterizing signal can contain information as to whether the person has entered a spatial protection area defined as critical. This can be digital information, in particular a simple “0” signal, or a “low” signal, or a “1” signal, or a “high” signal, or vice versa.

According to the invention, the control device is configured such that, as a function of the characterizing signal obtained by the sensor unit relating to the approach or the presence of the person in the critical spatial proximity to the laser projector, it adjusts the exposure parameters of the camera as a function of the reduced maximum irradiation intensity of the laser projector in relation to the current irradiation intensity of the laser projector.

The critical spatial proximity to the laser projector can be derived from whether there is a risk for the person who is approaching or present in a certain protection area that the person could get into the beam path of the laser projector with a body part, or there is a risk that an emitted laser beam or a reflected laser beam could hit the eye of the person. Depending on the specific configuration of the automated workstation, this critical spatial proximity can be very extensive, i.e. reached very early, or only reached in the immediate vicinity of the laser projector and/or the camera. For example, in certain configurations of the automated workstation, it may be necessary to reduce the maximum irradiation intensity of the laser projector if the person enters the automated workstation, for example by opening a door in a protective fence that encloses the automated workstation. In other configurations of the automated workplace, for example, it can be sufficient if the maximum irradiation intensity of the laser projector is only reduced if the person already present reaches into the pallet or box mentioned above, or bends his head into the pallet or box.

The exposure parameters of the camera can be adjusted so that the required features of the object can be recognized despite a reduced irradiation intensity of the laser projector. This can result in a particular individual detection or measurement requiring a longer measurement time than a single detection or measurement would require at a higher irradiation intensity of the laser projector. However, this is not critical in cases of non-automatic mode, in particular in set-up mode since, for example, a robot arm or another machine or machine tool of the automated workstation can only be moved at reduced speeds. In this respect, the arising longer measurement time of the laser-optical detection system is even better adjusted to the reduced speeds of the machine, machine tool or robot.

If a certain irradiation intensity of the laser projector is planned for the planned work process with a planned working speed of the robot in automatic mode, the irradiation intensity of the laser projector in non-automatic mode, in particular in a set-up mode, can be reduced in relation to the reduced movement speed of the robot in non-automatic mode, in particular in set-up mode, to the extent that a minimum irradiation intensity of the laser projector sufficient to detect the features of the objects still enables sufficient detection by the camera. The exposure parameters of the camera can be adjusted accordingly.

For example, the exposure time in non-automatic mode, in particular in set-up mode, can be doubled if the reduced movement speed of the robot in non-automatic mode, in particular in set-up mode, is less than half the planned working speed of the robot in automatic mode.

The irradiation intensity of the laser projector can be variable. In particular, the irradiation intensity of the laser projector can vary depending on the process; for example, depending on the required and selected radiation pattern, the irradiation intensity that is useful for this process or pattern can vary. In this respect, a change in the irradiation intensity of the laser projector can be possible or even necessary even without an approach of a person. Therefore, only the maximum irradiation intensity of the laser projector is to be reduced when a person approaches, wherein below this particular maximum irradiation intensity, the actual current irradiation intensity can possibly increase even starting from a very low value, but then not beyond the maximum irradiation intensity.

The irradiation intensity of the laser projector correlates with the irradiation intensity on the object and consequently also with the irradiation intensity of the laser light reflected from the object onto the image sensor of the camera.

In a further development of the method, the exposure parameter of the camera can be the exposure time, and the exposure time can be accordingly extended as a function of the reduced maximum irradiation intensity of the laser projector, adjusted to the current irradiation intensity of the laser projector.

In this respect, the laser-optical detection system can be designed and configured to extend the exposure time as a function of the reduced maximum irradiation intensity of the laser projector, adjusted to the current irradiation intensity of the laser projector.

In another development of the method, the exposure parameter of the camera can be the aperture diaphragm, and the aperture diaphragm can be accordingly opened as a function of the reduced maximum irradiation intensity of the laser projector, adjusted to the current irradiation intensity of the laser projector.

In this respect, the laser-optical detection system can be designed and configured to open the aperture diaphragm of the camera as a function of the reduced maximum irradiation intensity of the laser projector, adjusted to the current irradiation intensity of the laser projector.

In a special development of the method, the current irradiation intensity of the laser projector can be regulated by the control device to a value between 90 percent and 99 percent of the maximum irradiation intensity.

In this respect, the laser-optical detection system can be designed and configured to regulate the current irradiation intensity of the laser projector by the control device to a value between 90 percent and 99 percent of the maximum irradiation intensity.

The control device and the camera can be combined in a common camera device.

The camera device can have a secure input via which the signal characterizing the approach or presence of the person is fed from the sensor unit to the camera device using secure technology.

The camera device can have an interface connecting the control device to the camera, via which the required exposure parameters to be set due to the approach or presence of the person in a critical spatial proximity to the laser projector are transmitted to the camera.

As a function of the reduced maximum irradiation intensity of the laser projector, the exposure parameters of the camera can be simultaneously adjusted to the current irradiation intensity of the laser projector during ongoing detection of features of the object.

The sensor unit can be a sensitive safety device, in particular a safety device that works without contact from the group of light curtains, laser scanners, surveillance cameras, door switches and proximity switches, or in particular a pressure-sensitive safety device from the group of switch mats, switch strips or switch buffers.

The object is also achieved by a robotic workstation, having at least one robot, a workspace assigned to the robot, in which at least one object is handled or treated by the robot, and a laser-optical detection system according to one of the described embodiments or combinations of embodiments, for detecting features of the at least one object, wherein the robot is controlled on the basis of the detected features.

Specific embodiments of the invention are explained in more detail in the following descriptions with reference to the accompanying drawings. Specific features of these embodiments, possibly considered individually or in further combinations, can represent general features of the invention, regardless of the specific context in which they are mentioned.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 shows a flow chart of the steps in an exemplary method according to the principles of the present disclosure,

FIG. 2 shows a schematic representation of an exemplary automated workstation with a robot and a laser-optical detection system according to the principles of the present disclosure,

FIG. 3 shows a schematic representation of the laser-optical detection system,

FIG. 4 shows a schematic representation of a first embodiment variant of the laser-optical detection system with a distributed control device, and

FIG. 5 shows a schematic representation of a second embodiment variant of the laser-optical detection system with separate control devices in a camera device and a laser device.

### DETAILED DESCRIPTION

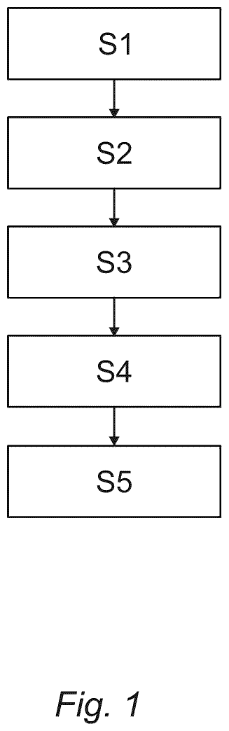

FIG. 1 schematically shows an exemplary method for actuating a laser-optical detection system 1.

In a first step S1, laser light of a predetermined pattern in a predetermined wavelength range with a predetermined irradiation intensity is projected onto an object 2.

In a second step S2, the pattern reflected from the object 2 which has been projected onto the object 2 is optically detected by means of a camera 3, which records an image 4 of the reflected pattern through an optical system 5 under predetermined exposure parameters.

In a third step S3, features 14 of the object 2 are determined on the basis of the recorded image 4 of the reflected pattern.

In a fourth step S4, a maximum irradiation intensity of the laser light is reduced to a permissible value as a function of an approach or presence of a person 6 in a critical spatial proximity to the laser light.

In a fifth step S5, the exposure parameters of the camera 3 are adjusted as a function of the reduced maximum irradiation intensity of the laser light.

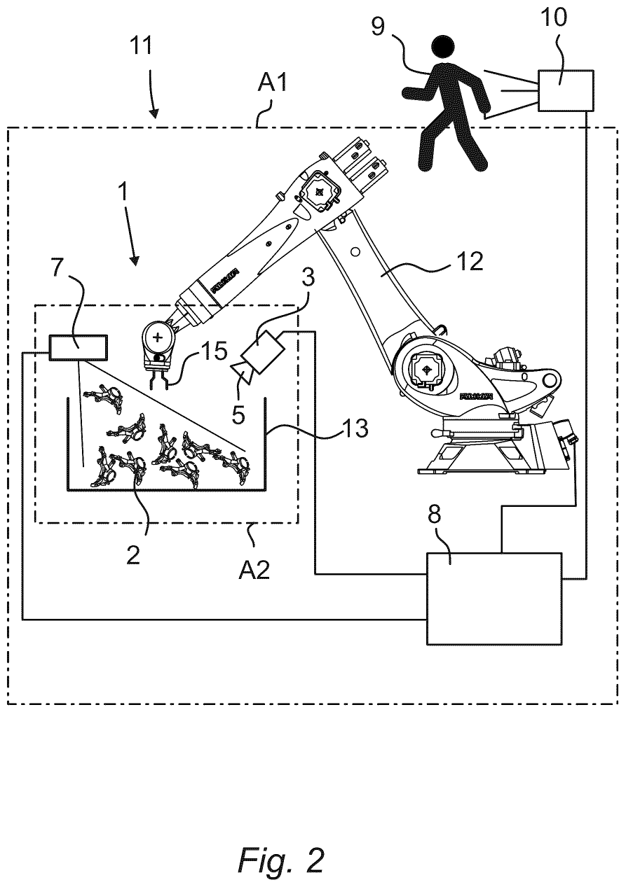

The laser-optical detection system 1 shown in FIG. 2 accordingly comprises:

A laser projector 7 that is designed to emit laser light of predetermined patterns in a predetermined wavelength range with a predetermined irradiation intensity to project it onto the object 2.

The camera 3, which is designed to optically detect the pattern reflected on the object 2, which is projected onto the object 2 by the laser projector 7, wherein the camera 3 is configured to detect the reflected pattern by the optical system 5 under predetermined exposure parameters.

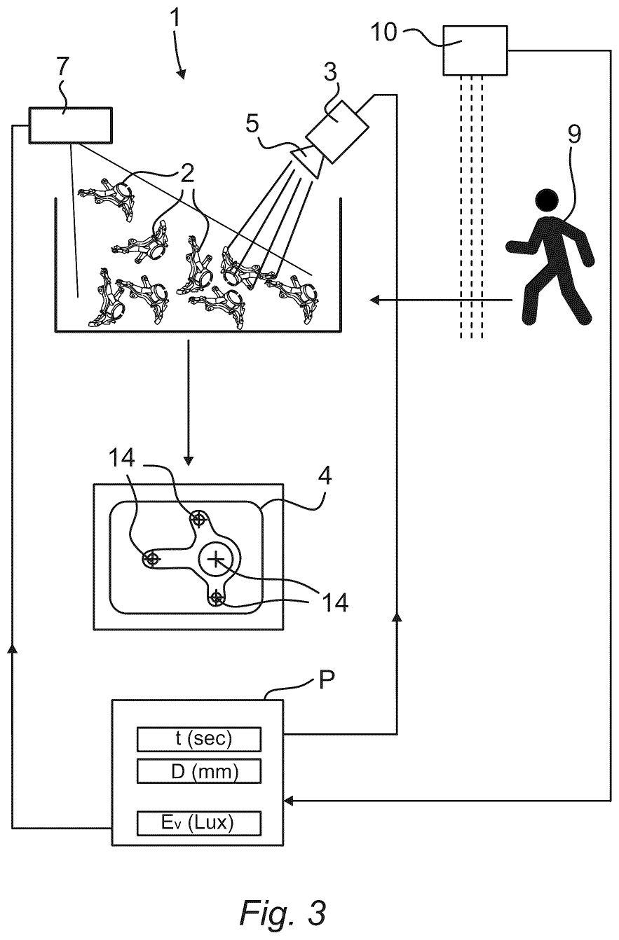

A control device 8 which is designed and configured to actuate the laser projector 7 and the camera 3 in order to determine features 14 of the object 2. The features 14 can, as shown in the exemplary embodiment of a cast component in FIG. 3, for example, be receiving bores in the cast component, which are known in their respective sizes, relative distances and positions. The robot can guide itself thereon in order to be able to pick up any object 2 lying in the box 13 by means of a gripper 15 (FIG. 2) automatically actuated as a function of the detection by means of the laser-optical detection system 1.

A sensor unit 10 which is designed to detect an approach or the presence of a person 9 in a critical spatial proximity to the laser projector 7, and which is configured to transmit a signal characterizing the approach or the presence of the person 9 to the control device 8, so that the control device 8 reduces the maximum irradiation intensity of the laser projector 7 to a permissible value based on the characterizing signal as a function of the approach or the presence of the person 9.

The control device 8 is configured such that, as a function of the characterizing signal obtained by the sensor unit 10 relating to the approach or the presence of the person 9 in the critical spatial proximity to the laser projector 7, it adjusts the exposure parameters of the camera 3 as a function of the reduced maximum irradiation intensity of the laser projector 7 in relation to the current irradiation intensity of the laser projector 7.

FIG. 2 shows a robotic workstation 11 having at least one robot 12, a workspace A1, A2 assigned to the robot 12, in which the at least one object 2 is handled or treated by the robot 12, and the laser-optical detection system 1 for detecting features of the at least one object 2, wherein the robot 12 is actuated on the basis of the detected features.

The workspace can be defined differently depending on the individual design of the robotic workstation 11. For example, a first workspace A1 can enclose the entire cell of the robotic workstation 11. Alternatively or additionally, a second workspace A2 can be chosen to be significantly smaller, for example as shown, small enough that basically only a narrow region around a box 13, the contents of which are to be detected by the laser-optical detection system 1, is monitored. Depending on the size and location of the workspace A1, A2, the type of sensor unit 10 must be accordingly determined, and the sensor unit 10 must be accordingly configured so that an approach or the presence of the person 9 to the respective workspace A1, A2 can be recognized.

As the diagram in FIG. 3 shows, an exposure parameter P of the camera 3 can be changed in the laser-optical detection system 1. The exposure parameter P can be the exposure time t, and the exposure time t can be accordingly extended as a function of the reduced maximum irradiation intensity Ev of the laser projector 7 adjusted to the current irradiation intensity of the laser projector 7.

Alternatively or additionally, the exposure parameter P of the camera 3 can be the aperture diaphragm D, and the aperture diaphragm D can be accordingly opened as a function of the reduced maximum irradiation intensity Ev of the laser projector 7, adjusted to the current irradiation intensity of the laser projector 7.

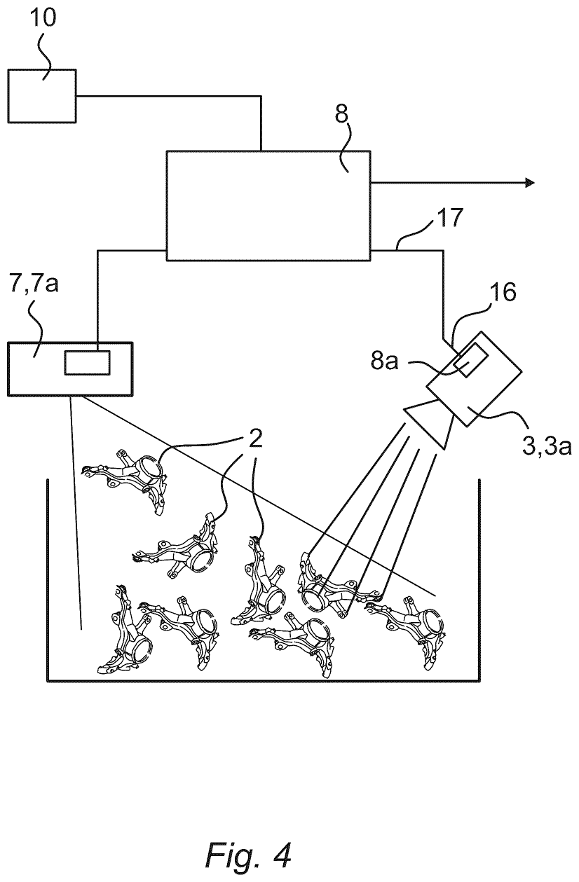

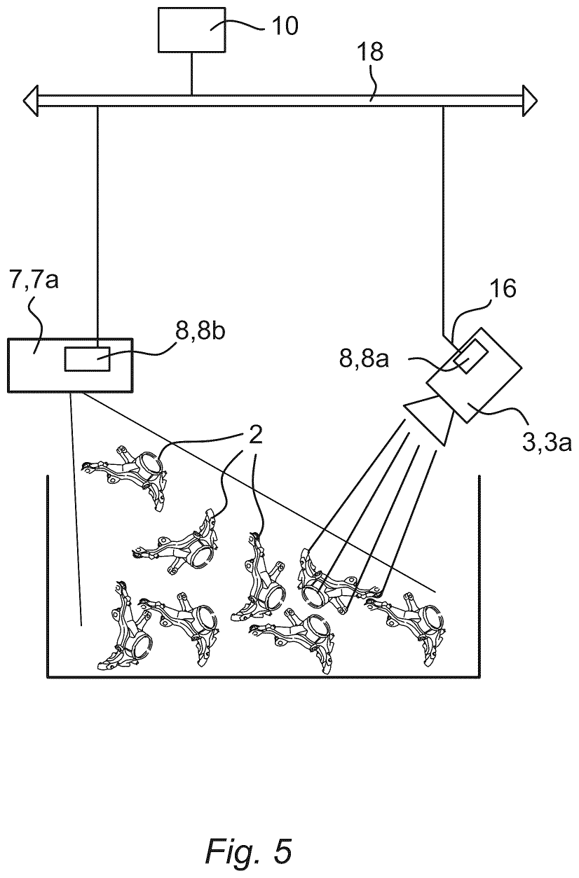

The control device 8 or a subcomponent 8a of the control device 8 and the camera 3 can be combined in a common camera device 3a, as shown in FIG. 4 and FIG. 5.

The control device 8 or a further subcomponent 8b of the control device 8 and the laser projector 7 can be combined in a common laser device 7a, as shown in FIG. 4 and FIG. 5.

The camera device 3a can have a secure input 16 via which the signal characterizing the approach or presence of the person 9 can be fed from the sensor unit 10 into the camera device 3a using secure technology.

The camera device 3a can have an interface 17 connecting the control device 8 to the camera 3, via which the exposure parameters P to be set due to the approach or presence of the person 9 in a critical spatial proximity to the laser projector 7 are transmitted to the camera 3.

As a function of the reduced maximum irradiation intensity Ev of the laser projector 7, the exposure parameters P of the camera 3 can be simultaneously adjusted to the current irradiation intensity Ev of the laser projector 7 during ongoing detection of the features 14 of the object 2.

As shown in FIG. 5, in a special embodiment, the laser projector 7, the camera 3 and the sensor unit 10 can be configured to communicate with each other via a data bus 18.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

What is claimed is:

1. A method for controlling a laser-optical detection system (1), comprising the steps:
projecting laser light of a predetermined pattern in a predetermined wavelength range with a predetermined irradiation intensity (Ev) onto an object (2),
optically detecting the pattern reflected from the object (2) which has been projected onto the object (2) by means of a camera (3), which records an image (4) of the reflected pattern through an optical system (5) under predetermined exposure parameters (P),
determining features of the object (2) based on the recorded image (4) of the reflected pattern,
reducing a maximum irradiation intensity (Ev) of the laser light to a permissible value as a function of an approach or presence of a person (9) in a critical spatial proximity to the laser light, and
adjusting the exposure parameters (P) of the camera (3) as a function of the reduced maximum irradiation intensity (Ev) of the laser light.

2. The method according to claim 1, characterized in that the exposure parameter of the camera (3) is the exposure time (t), and the exposure time (t) is accordingly extended, adjusted as a function of the reduced maximum irradiation intensity (Ev) of the laser light.

3. The method according to claim 1 or 2, characterized in that the exposure parameter of the camera (3) is the aperture diaphragm (D), and the aperture diaphragm (D) is accordingly opened, adjusted as a function of the reduced maximum irradiation intensity (Ev) of the laser light.

4. The method according to one of claims 1 to 3, characterized in that the current irradiation intensity (Ev) of the laser light is regulated to a value between 90 percent and 99 percent of the maximum irradiation intensity (Ev).

5. A laser-optical detection system, in particular for carrying out the method according to one of claims 1 to 4, comprising:
a laser projector (7) that is designed to emit laser light of predetermined patterns in a predetermined wavelength range with a predetermined irradiation intensity (Ev) to project it onto an object (2),
a camera (3) which is designed to optically detect the pattern reflected on the object (2), which is projected onto the object (2) by the laser projector (7), wherein the camera (3) is configured to detect the reflected pattern by an optical system (5) under predetermined exposure parameters (P),
a control device (8) which is designed and configured to actuate the laser projector (7) and the camera (2) in order to determine features (14) of the object (2),
a sensor unit (10) which is designed to detect an approach or the presence of a person (9) in a critical spatial proximity to the laser projector (7) and which is configured to transmit a signal characterizing the approach or the presence of the person (9) to the control device (8), so that the control device (8) reduces the maximum irradiation intensity (Ev) of the laser projector (7) to a permissible value based on the characterizing signal as a function of the approach or the presence of the person (9), characterized in that
the control device (8) is configured such that, as a function of the characterizing signal obtained by the sensor unit (10) relating to the approach or the presence of the person (9) in the critical spatial proximity to the laser projector (7), it adjusts the exposure parameters (P) of the camera (3) as a function of the reduced maximum irradiation intensity (EV) of the laser projector (7) in relation to the current irradiation intensity (EV) of the laser projector (7).

6. The laser-optical detection system according to claim 5, characterized in that the control device (8) and the camera (3) are combined in a common camera device (3a).

7. The laser-optical detection system according to claim 6, characterized in that the camera device (3a) has a secure input (16) via which the signal characterizing the approach or presence of the person (9) is fed from the sensor unit (10) into the camera device (3a) using secure technology.

8. The laser-optical detection system according to claim 6 or 7, characterized in that the camera device (3a) has an interface (17) connecting the control device (8) to the camera (3), via which the exposure parameters (P) to be set due to the approach or presence of the person (9) in a critical spatial proximity to the laser projector (7) are transmitted to the camera (3).

9. The laser-optical detection system according to one of claims 5 to 8, characterized in that as a function of the reduced maximum irradiation intensity (Ev) of the laser projector (7), the exposure parameters (P) of the camera (3) are simultaneously adjusted to the instantaneous irradiation intensity (Ev) of the laser projector (7) during an ongoing detection of features (14) of the object (2).

10. The laser-optical detection system according to one of claims 5 to 9, characterized in that the sensor unit (10) is a sensitive safety device, in particular a safety device the works without contact from the group of light curtains, laser scanners, surveillance cameras, door switches and proximity switches, or in particular is a pressure-sensitive safety device from the group of switch mats, switch strips or switch buffers.

11. A robotic workstation, having at least one robot (12), a workspace (A1, A2) assigned to the robot (12), in which at least one object (2) is handled or treated by the robot (12), and a laser-optical detection system (1) according to one of claims 5 to 10 for detecting features (14) of the at least one object (2), wherein the robot (12) is controlled on the basis of the detected features (14).
